(19) United States
(12) Patent Application Publication
(10) Pub. No.: US 2021/0201287 A1
(43) Pub. Date: Jul. 1, 2021

(54) WALLET SERVER, COMPUTER READABLE RECORDING MEDIUM, AND WALLET SYSTEM

(71) Applicant: TOYOTA JIDOSHA KABUSHIKI KAISHA, Toyota-shi (JP)

(72) Inventors: Tomokazu MAYA, Nagoya-shi (JP); Naoki YAMAMURO, Nagoya-shi (JP); Yuki NAKATANI, Tokyo-to (JP); Kosuke MIYAKE, Tokyo-to (JP); Soushi MIZUNO, Tokyo-to (JP); Yasushi FURUHATA, Kodaira-shi (JP); Masataka NARITA, Tokyo-to (JP); Yasuhiro TAKEHARA, Nagoya-shi (JP)

(73) Assignee: TOYOTA JIDOSHA KABUSHIKI KAISHA, Toyota-shi (JP)

(21) Appl. No.: 17/132,870

(22) Filed: Dec. 23, 2020

(30) Foreign Application Priority Data
Dec. 26, 2019 (JP) 2019-237288

(51) Int. Cl. G06Q 20/22; G06Q 20/32; G06Q 20/36

(52) U.S. Cl. CPC G06Q 20/227; G06Q 20/367; G06Q 20/3223

(57) ABSTRACT

A wallet server includes: a processor including hardware, the processor being configured to: display, on a display, a payment icon receiving a request for payment using any of a plurality of different payment methods, and additional information determined based on a result of comparison between a balance of each payment method and a predetermined amount.

The present application claims priority to and incorporates by reference the entire contents of Japanese Patent Application No. 2019-237288 filed in Japan on Dec. 26, 2019.

### BACKGROUND

The present disclosure relates to a wallet server, a computer readable recording medium, and a wallet system.

In the related art, there has been known a technique of identifying a payment method, which uses a terminal of a user and a payment terminal, based on positional information of the terminal used by the user and positional information of the payment terminal installed in a store.

### SUMMARY

There is a need for a wallet server, a computer readable recording medium, and a wallet system that improve convenience of a wallet system in which a plurality of payment methods may be used.

According to one aspect of the present disclosure, there is provided a wallet server includes: a processor including hardware, the processor being configured to: display, on a display, a payment icon receiving a request for payment using any of a plurality of different payment methods, and additional information determined based on a result of comparison between a balance of each payment method and a predetermined amount.

### BRIEF DESCRIPTION OF THE DRAWINGS

FIG. 1 is a view schematically illustrating a configuration of a wallet system including a wallet server according to an embodiment;

FIG. 2 is a block diagram illustrating details of each component of the wallet system including the wallet server according to the embodiment;

FIG. 3 is a view schematically illustrating a relationship between a wallet and a payment method in the wallet system including the wallet server according to the embodiment;

FIG. 4 is a view illustrating an example in which a list of a plurality of payment methods is displayed on an operation/display unit of a user terminal in the wallet server according to the embodiment;

FIG. 5 is a view illustrating an example in which a list of a plurality of payment methods is displayed on the operation/display unit of the user terminal in the wallet server according to the embodiment;

FIG. 6 is a view illustrating an example in which a list of a plurality of payment methods is displayed on the operation/display unit of the user terminal in the wallet server according to the embodiment; and

FIG. 7 is a view illustrating an example in which a purchased amount input screens is displayed on the operation/display unit of the user terminal in the wallet server according to the embodiment.

### DETAILED DESCRIPTION

A wallet server, a wallet program, and a wallet system according to an embodiment of the present disclosure will be described with reference to the drawings. Note that components in the following embodiment include what may be easily replaced by those skilled in the art or what is substantially the same.

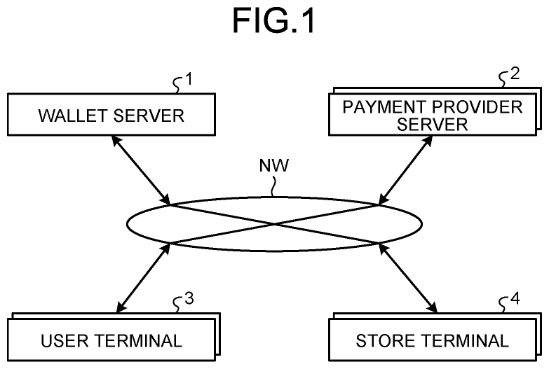

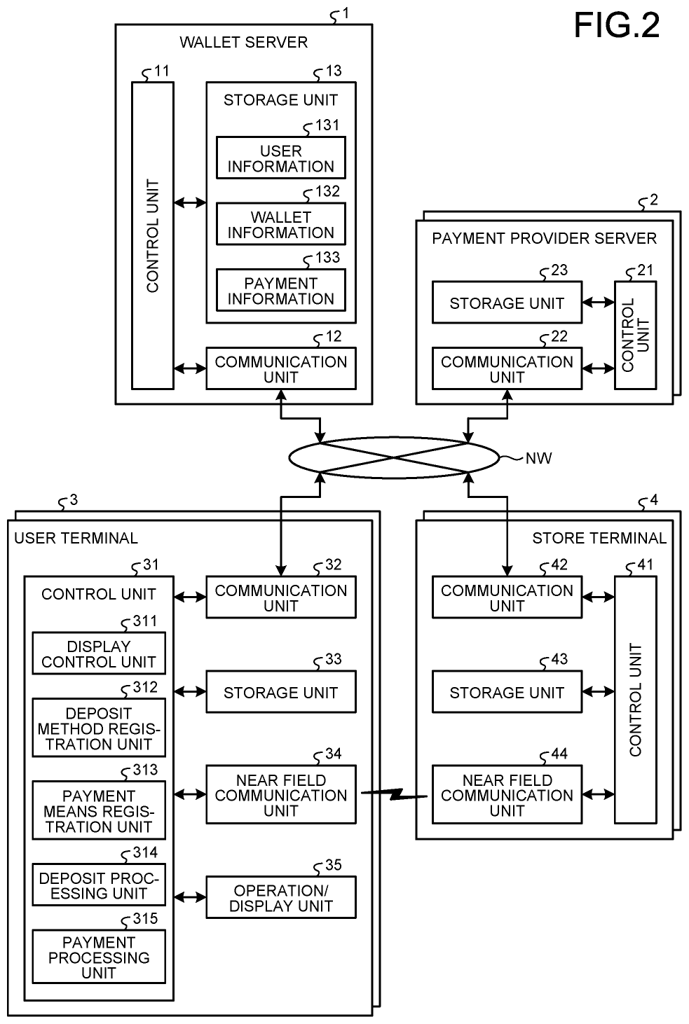

A configuration of a wallet system according to the present embodiment will be described with reference to FIG. 1 and FIG. 2. As illustrated in FIG. 1, the wallet system includes a wallet server 1, a payment provider server 2, a user terminal 3, and a store terminal 4.

The wallet server 1, the payment provider server 2, the user terminal 3, and the store terminal 4 are configured in a manner of being able to communicate with each other through a network NW. This network NW includes, for example, an Internet network, a mobile phone network, or the like.

The wallet server 1 is a server to comprehensively manage the wallet system, and is managed by an administrator of the wallet system. As illustrated in FIG. 2, the wallet server 1 includes a control unit (first processor) 11, a communication unit 12, and a storage unit 13.

More specifically, the control unit 11 includes a processor including a central processing unit (CPU), a digital signal processor (DSP), a field-programmable gate array (FPGA), and the like, and a memory (main storage unit) such as a random access memory (RAM) and read only memory (ROM).

The control unit 11 loads and executes a program stored in the storage unit 13 on a work area of the main storage unit, and controls each configuration unit and the like through execution of the program, thereby a function that meets a predetermined purpose is realized.

The communication unit 12 includes, for example, a local area network (LAN) interface board, a wireless communication circuit for wireless communication, and the like. The communication unit 12 is connected to a network NW such as the Internet that is a public communication network. Then, the communication unit 12 is connected to the network NW and communicates with the payment provider server 2, the user terminal 3, and the store terminal 4.

The storage unit 13 includes a recording medium such as an erasable programmable ROM (EPROM), a hard disk drive (HDD), and a removable medium. Examples of the removable medium include a universal serial bus (USB) memory, and disc recording media such as a compact disc (CD), a digital versatile disc (DVD), and a Blu-ray (registered trademark) disc (BD). The storage unit 13 may store an operating system (OS), various programs, various tables, various databases, and the like. The storage unit 13 according to the present embodiment stores user information 131, wallet information 132, and payment information 133 of each user of the wallet system.

The user information 131 is information related to a user that uses the wallet system. Examples of the user information 131 include a user ID, password, user name, user contact information (such as address, phone number, and email address), usage registration history, information of a registered payment method, information related to other payment methods registered for a deposit into the payment method, passcode at payment, and the like of a user that performs usage registration into the wallet system. Note that the user ID and password in the user information 131 are used for authentication processing such as a login to the wallet server 1.

The wallet information 132 is information related to a wallet of the wallet system. The wallet is an application that manages a virtual deposit/withdrawal using various payment methods such as a credit card and electronic money. Examples of the wallet information 132 include a user ID, a payment method, a balance of electronic money, a deposit history of the electronic money, a usage history of the electronic money, and the like.

The payment information 133 is information related to payment in the wallet system. The payment information 133 includes a user ID, a payment means used for payment (such as electronic money payment (contactless payment), scan payment, or code payment), a payment history, and the like.

The payment provider server 2 is a server to manage an account and a credit card of a user, and is provided in a financial institution (such as bank, shinkin bank, credit union, or labor bank) and a credit card company. The payment provider server 2 includes a control unit 21, a communication unit 22, and a storage unit 23. The control unit 21, the communication unit 22, and the storage unit 23 are physically similar to the control unit 11, the communication unit 12, and the storage unit 13.

The storage unit 23 stores account information and credit card information of each user of the wallet system. Examples of the account information include a user name, account number, account balance, deposit/withdrawal history, and the like. Moreover, examples of the credit card information include a user name, credit card number, credit card expiration date, usage limit amount, card usage history, and the like.

The user terminal 3 is a computer terminal used by a user. Examples of the user terminal 3 include a smartphone, mobile phone, tablet terminal, wearable computer, personal computer, in-vehicle car navigation system, and the like owned by the user. The user terminal 3 may be any terminal as long as information may be exchanged with the wallet server 1.

The user terminal 3 includes a control unit 31, a communication unit 32, a storage unit 33, a near field communication unit 34, and an operation/display unit (display) 35. The control unit 31, the communication unit 32, and the storage unit 33 are physically similar to the control unit 11, the communication unit 12, and the storage unit 13. The control unit 31 functions as a display control unit 311, a deposit means registration unit 312, a payment method registration unit 313, a deposit processing unit 314, and a payment processing unit 315 through execution of a program.

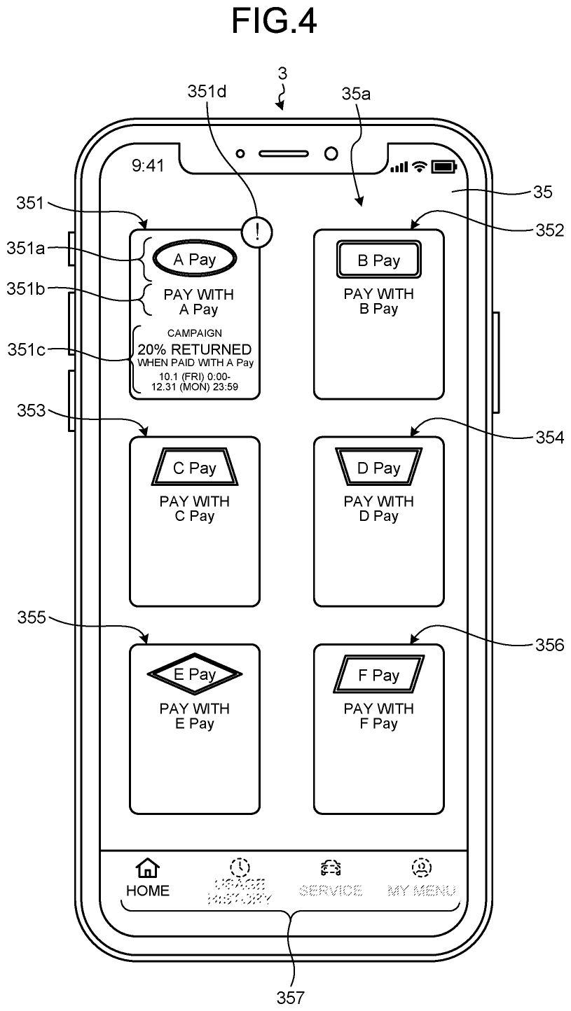

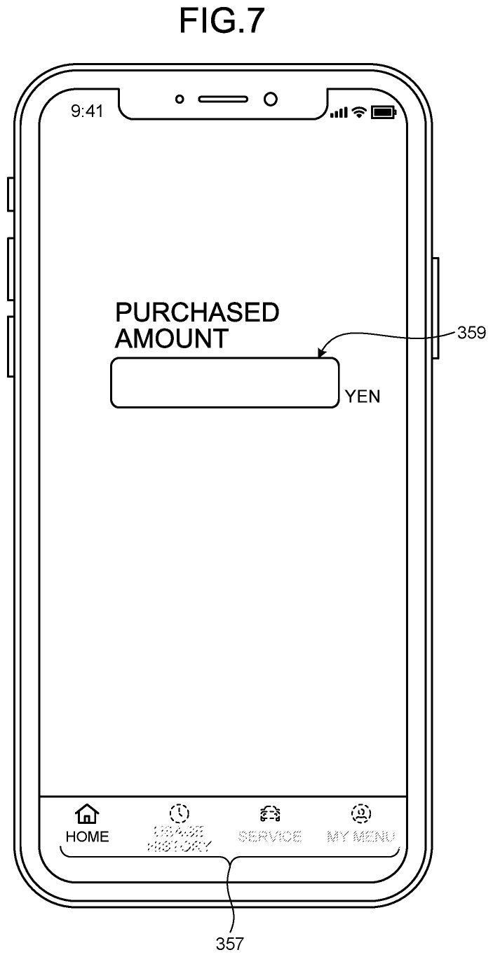

The display control unit 311 controls display contents on the operation/display unit 35. Based on an operation (such as touch operation or flick operation) by a user, the display control unit 311 displays, on the operation/display unit 35, a member registration screen of when the user performs member registration, a login screen in a login to the wallet system, a deposit screen in a deposit of electronic money in a wallet, a payment screen 35a in performance of payment (see FIG. 4 to FIG. 6 described later), a purchased amount input screen 35b to input a purchased amount (see FIG. 7 described later), and the like. Moreover, the display control unit 311 causes each screen to transition based on an operation by the user. Note that details of the payment screen 35a, the purchased amount input screen 35b, and the like will be described later.

The deposit means registration unit 312 registers a deposit means to deposit electronic money. More specifically, to the wallet server 1, the deposit means registration unit 312 transmits a deposit means registration request for registering, as deposit means of electronic money, a plurality of different payment methods (such as bank account and credit card) operated by a plurality of business operators. The control unit 11 of the wallet server 1 that receives the deposit means registration request from the deposit means registration unit 312 registers, as deposit means, payment methods included in the deposit means registration request by performing storing thereof into the storage unit 13 as the user information 131.

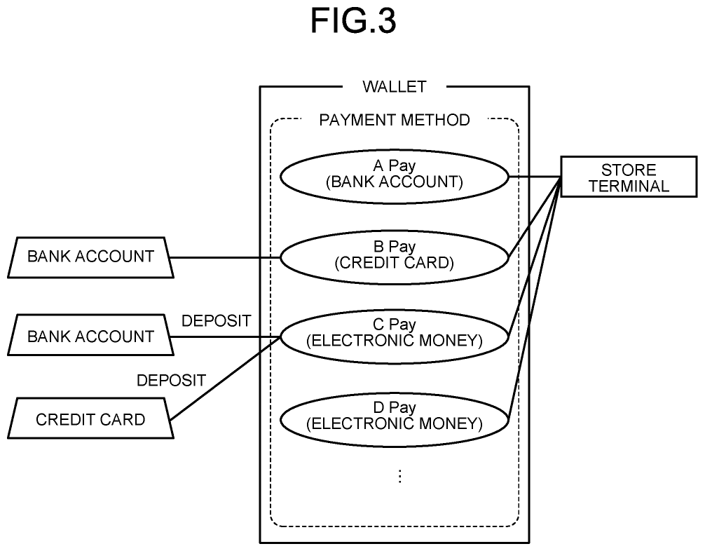

Here, FIG. 3 is a view schematically illustrating a relationship between a wallet and payment methods in the wallet system. The “payment method” means payment funds (funding source) for payment. In the wallet, a plurality of payment methods such as “A Pay” that is payment by a bank account, “B Pay” that is payment by a credit card, and “C Pay” and “D Pay” that are payment by electronic money is registered. The “A Pay” is a payment method in which a payment amount is directly deducted from a bank account. Moreover, a bank account is associated with each credit card (“B Pay”), and a usage amount of each card is deducted from the bank account at a later date. Moreover, deposit means that are means to deposit electronic money and that are, for example, a bank account and a credit card are associated with the electronic money (“C Pay”), and it is possible to deposit the electronic money. Moreover, in a case where the electronic money (“D Pay”) is a prepaid type in which a deposit of cash or the like is performed in advance, deposit means such as a bank account and a credit card are not necessarily associated with the electronic money.

Then, payment is performed between the user terminal 3 and the store terminal 4 by a payment method selected by the user from these payment methods. More specifically, when the user terminal 3 is held over the store terminal 4, a payment means such as payment performed in a contactless manner, payment performed by reading of a bar code or QR code (registered trademark) displayed on the store terminal 4 with a camera or the like of the user terminal 3, or payment performed by reading of a barcode or QR code (registered trademark) displayed on the user terminal 3 with a code reader or the like of the store terminal 4 is executed between the near field communication unit 34 of the user terminal 3 and a near field communication unit 44 of the store terminal 4.

The payment method registration unit 313 registers various payment methods. The payment method registration unit 313 transmits a payment method registration request for registration of a payment method to the wallet server 1. The control unit 11 of the wallet server 1 that receives the payment method registration request from the payment method registration unit 313 registers, as a payment method, a payment method included in the payment method registration request by performing storing thereof into the storage unit 13 as the user information 131.

The deposit processing unit 314 deposits electronic money in the wallet. More specifically, the deposit processing unit 314 transmits, to the wallet server 1, a deposit request for a deposit of electronic money by a payment method registered as a deposit means. The control unit 11 of the wallet server 1 that receives the deposit request from the deposit processing unit 314 increases a balance of the electronic money in the wallet based on deposit amount information included in the deposit request. That is, the control unit 11 updates the wallet information 132 stored in the storage unit 13 according to an increased amount of the balance of electronic money in the wallet.

The payment processing unit 315 executes payment by the payment method selected by the user. More specifically, as a payment means, the payment processing unit 315 transmits a payment request to the store terminal 4 through the near field communication unit 34. Moreover, as a payment means, the payment processing unit 315 may transmit a payment request to the store terminal 4 by reading a bar code or QR code (registered trademark) displayed on the store terminal 4 with a camera or the like of the user terminal 3. Moreover, as a payment means, the payment processing unit 315 may transmit a payment request to the store terminal 4 by causing a code reader or the like of the store terminal 4 to read a barcode or QR code (registered trademark) displayed on the user terminal 3. Note that the payment request transmitted from the payment processing unit 315 to the store terminal 4 may or may not include information indicating a payment amount (hereinafter, referred to as “payment amount information”).

Then, in a case of payment by a bank account or a credit card, the payment processing unit 315 transmits, to the wallet server 1, a payment request for the payment using any of the payment means. The control unit 11 of the wallet server 1 that receives the payment request from the payment processing unit 315 transmits payment amount information included in the payment request to the payment provider server 2.

Moreover, in a case of payment by electronic money, the payment processing unit 315 transmits a payment request including payment amount information to the wallet server 1 through the network NW by a control unit 41 of the store terminal 4 (described later). The control unit 11 of the wallet server 1 that receives the payment request from the store terminal 4 decreases the balance of the electronic money in the wallet based on the payment amount information included in the payment request. That is, the control unit 11 updates the wallet information 132 and the payment information 133 stored in the storage unit 13 according to a decreased amount of the balance of the electronic money in the wallet.

The storage unit 33 stores data of various screens displayed on the operation/display unit 35 by the display control unit 311. Moreover, the storage unit 33 temporarily stores the user information 131, the wallet information 132, the payment information 133, and the like when necessary.

The near field communication unit 34 has a communication function based on a standard such as near field radio communication (NFC), Bluetooth (registered trademark) low energy (BLE), or infrared data association (IrDA). The user terminal 3 performs near field communication with the store terminal 4 through the near field communication unit 34, for example, when payment by electronic money is performed.

The operation/display unit 35 includes, for example, a touch panel display, and has an input function of receiving an operation by a finger of a user, a pen, or the like, and a display function of displaying various kinds of information under the control by the display control unit 311.

The store terminal 4 is provided, for example, in a store (member store) in which the wallet system may be used. However, the store terminal 4 may be a server that functions as a virtual store opened on the Internet (so-called electronic commerce site). The store terminal 4 includes a control unit 41, a communication unit 42, a storage unit 43, and a near field communication unit 44. The control unit 41, the communication unit 42, the storage unit 43, and the near field communication unit 44 are physically similar to the control unit 11, the communication unit 12, the storage unit 13, and the near field communication unit 34.

Hereinafter, display control performed on the operation/display unit 35 by the display control unit 311 in the wallet system including the wallet server 1 according to the present embodiment will be described with reference to FIG. 4 to FIG. 7.

FIG. 4 to FIG. 6 are views illustrating an example of the payment screen 35a displayed on the operation/display unit 35 by the display control unit 311. In the drawings, a payment screen 35a of a case where “A Pay”, “B Pay”, “C Pay”, “D Pay”, “E Pay” and “F Pay” are registered as payment methods is illustrated as an example. More specifically, the payment screen 35a includes payment icons 351 to 356 displayed as a list and a menu switching region 357. The payment screen 35a is a screen displayed, for example, when a wallet application is opened.

The payment icons 351 to 356 are regions to display payment methods, and receive requests for payment using the displayed payment methods. The display control unit 311 displays, on the payment icon 351, a payment name 351a indicating a name of a payment method that may be used by the user terminal 3, a payment phrase 351b clearly indicating that payment is performed by the payment method, a payment information region 351c in which additional information related to each payment method is displayed, and a notification icon 351d that is additional information notifying of a campaign.

More specifically, in the payment icon 351, a mark (such as logo or acceptance mark) including a name of “A Pay” is displayed as the payment name 351a, characters “pay with A Pay” are displayed as the payment phrase 351b, information of a campaign is displayed as a service related to the “A Pay” in the payment information region 351c, and the notification icon 351d to make a user recognize this campaign is displayed. Each of the payment icons 352 to 356 also displays a name of a payment method, a mark indicating the payment method, a payment phrase, additional information, and the like, and is functionally similar to the payment icon 351.

Here, in FIG. 4, in a case where the payment icon 351 indicating the “A Pay” is selected by a user, the display control unit 311 displays a previously-prepared screen for electronic payment. More specifically, between the near field communication unit 34 and the near field communication unit 44, the display control unit 311 displays a screen on which a message prompting a contactless payment is displayed, a previously-prepared screen for scan payment, a previously-prepared screen for code payment, or the like.

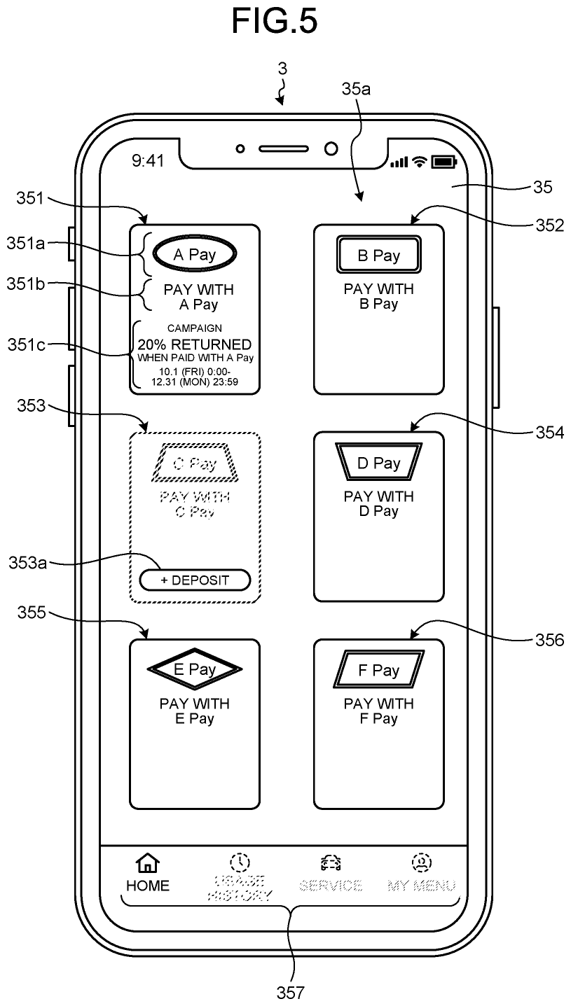

The display control unit 311 displays, as additional information determined based on a result of comparison between a balance of each payment method and a predetermined amount, a payment method in which a balance of electronic money is smaller than the predetermined amount in a display mode different from those of the other payment methods. More specifically, as illustrated in FIG. 5, in a case where a balance of electronic money (“C Pay”) is smaller than a predetermined amount, the display control unit 311 displays a payment icon 353 of this payment method in a gray-out manner. The predetermined amount may be, for example, an amount set in advance. Here, even when a user selects the payment icon 353, payment is not performed. Moreover, it may be made impossible for a user to select the payment icon 353 when the payment icon 353 is in a gray-out state. As a result, the user may easily recognize a payment method in which a balance is smaller than the predetermined amount and which is highly likely to be unavailable for payment, and convenience is improved.

Moreover, as illustrated in FIG. 5, the display control unit 311 may display a deposit button 353a (“+ deposit”) to receive a request for a deposit into this payment method in a superimposed manner on the gray-out payment icon 353. When the user selects the deposit button 353a, a predetermined amount set in advance is deposited from the above-described deposit means into the electronic money (“C Pay”). As a result, the user may easily make a deposit in a case where the balance is smaller than the predetermined amount, and convenience is improved. Note that when the user selects the deposit button 353a, a screen for the user to select a deposit means to perform a deposit from a plurality of different deposit means (such as bank account and credit card) may be displayed. Similarly, a screen for the user to input a deposit amount may be displayed. Note that the display control unit 311 may display a deposit button in a superimposed manner on a payment button that is not in a gray-out state.

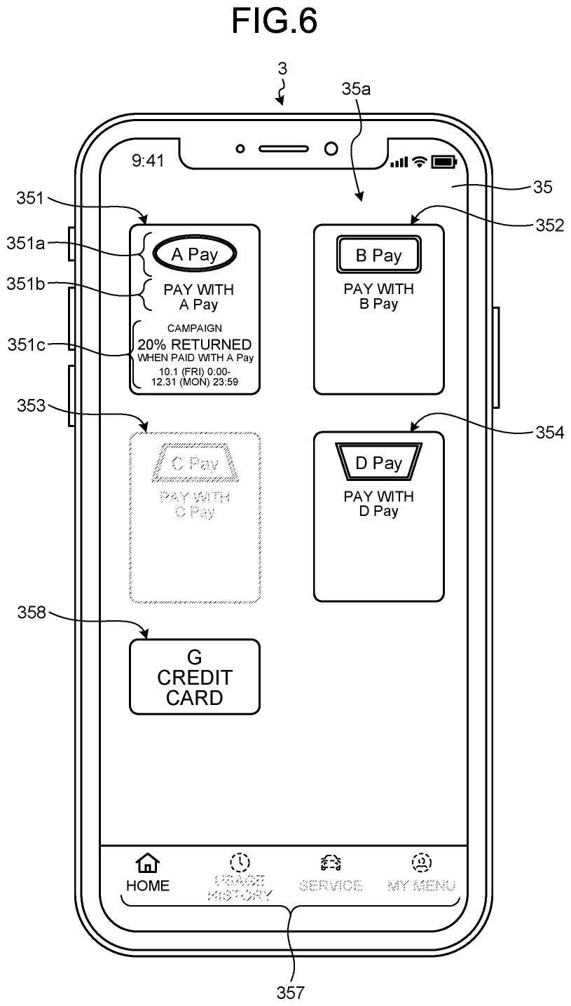

Moreover, as illustrated in FIG. 6, the display control unit 311 may display a deposit icon 358 indicating a deposit means such as a credit card. By touching this deposit icon 358 and dragging the icon to a payment icon of a payment method into which money is deposited, the user may deposit a predetermined amount set in advance into this payment method. As a result, the user may easily make a deposit and convenience is improved. Note that when the user repeats the drag operation from the deposit icon 358 to the same payment method for a plurality of times, a deposit into the payment method for a predetermined amount may be repeated for the number of times of the operation.

Moreover, the predetermined amount may be set by the user. More specifically, the user may input the predetermined amount. Moreover, the predetermined amount may be set based on an object of payment by the user (such as convenience store, restaurant, or taxi). More specifically, the object of payment may be input by the user, or may be input by reading of a barcode or QR code (registered trademark) displayed on the store terminal 4 with a camera or the like of the user terminal 3. As a result, the user may easily recognize electronic money having a balance smaller than a predetermined amount set according to an object to be used, and convenience is improved.

Moreover, the predetermined amount may be set based on positional information of the user terminal 3 measured by reception of a signal from a global positioning system (GPS) satellite. For example, in a case where the positional information of the user terminal 3 indicates a store such as a convenience store in which a payment amount is estimated to be small, the predetermined amount is set small (such as 1000 yen). On the one hand, in a case where the positional information of the user terminal 3 indicates a store such as a hotel, restaurant, or department store in which a payment amount is estimated to be large, the predetermined amount is set large (such as 10000 yen). As a result, the user may easily recognize electronic money that has a balance smaller than a predetermined amount set according to a store to be used, and convenience is improved.

Moreover, the predetermined amount may be a payment amount. For example, the user inputs a payment amount in a purchased amount input field 359 on the purchased amount input screen 35b illustrated in FIG. 7. When the payment amount is input, the payment screen 35a is displayed again and the display control unit 311 displays, in a gray-out manner, electronic money with a balance smaller than the payment amount. As a result, the user may recognize electronic money with a balance smaller than the payment amount, and convenience is improved. Moreover, a barcode or QR code (registered trademark) displayed on the store terminal 4 includes information related to a payment amount. This barcode or QR code (registered trademark) may be read with the camera or the like of the user terminal 3, and the payment amount may be input into the user terminal 3.

Moreover, the display control unit 311 may display the payment methods (“A Pay” to “F Pay”) side by side in order determined according to a preference of the user. The preference of the user is information that indicates a preference, which is related to payment, of the user and that is preferentially displaying a payment method with a cash back, preferentially displaying a payment method with which a coupon may be used, or preferentially displaying a payment method with a high point return rate, for example. The preference of the user may be input by the user or may be set by machine learning based on a usage history of each payment method by the user. As a result, the payment methods are displayed side by side in order corresponding to the preference of the user. Thus, the user may easily select a preferred payment method and convenience is improved. Similarly, displaying may be performed with a display mode (such as color or pattern) being changed according to a preference of the user or an attribute of a payment method (such as bank account, credit card, type or balance of electronic money, or presence/absence of a campaign or coupon).

Moreover, the display control unit 311 may display a balance of electronic money in a superimposed manner on a payment icon. As a result, the user may easily recognize the balance of the electronic money and convenience is improved.

Moreover, the display control unit 311 may display the payment methods in order of usage of the payment methods (payment method used most recently is displayed preferentially), order of an update of information such as campaign information (payment method with most recently-updated information is preferentially displayed), or order of ends of campaigns.

The menu switching region 357 is a region to switch menu items. In the examples illustrated in FIG. 4 to FIG. 7, a home, usage history, service, and my menu are included as the menu items. The “home” is a menu item to display the payment screen 35a.

As described above, according to a wallet server, wallet program, and wallet system according to the present embodiment, convenience of a wallet system in which a plurality of payment methods may be used may be improved.

Further effects and modification examples may be easily derived by those skilled in the art. Accordingly, broader aspects of the present disclosure are not limited by the specific details and representative embodiments that are illustrated and described in the above manner. Thus, various modifications may be made without departing from the sprit or scope of a general concept of the disclosure defined by the accompanying claims and an equivalent thereof.

For example, in addition to face-to-face payment such as electronic money payment, scan payment, and code payment in an actual store in a manner illustrated in FIG. 3, a wallet system including a wallet server according to the present embodiment may be also used in electronic commerce on the Internet.

Moreover, in a case where a user terminal 3 is a car navigation system mounted in a vehicle, a wallet system including a wallet server according to the present embodiment may be also used in payment performed during driving of the vehicle.

According to the present disclosure, convenience is improved since additional information of a plurality of payment methods is displayed.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wallet server comprising:
a processor comprising hardware, the processor being configured to:
display, on a display, a payment icon receiving a request for payment using any of a plurality of different payment methods, and additional information determined based on a result of comparison between a balance of each payment method and a predetermined amount.

2. The wallet server according to claim 1, wherein the additional information is information displaying a payment method, the payment method having the balance smaller than the predetermined amount, in a display mode different from those of other payment methods.

3. The wallet server according to claim 2, wherein the display mode is a mode in which the payment icon of the payment method with the balance smaller than the predetermined amount is displayed in a gray-out manner.

4. The wallet server according to claim 1, wherein the payment icons respectively include display of names of the payment methods or marks indicating the payment methods.

5. The wallet server according to claim 1, wherein the processor is configured to display a list of the plurality of payment icons on the display.

6. The wallet server according to claim 1, wherein the processor is configured to display, on the display, a deposit button to receive a request for a deposit into a payment method.

7. The wallet server according to claim 1, wherein the predetermined amount is a payment amount.

8. The wallet server according to claim 1, wherein the processor is configured to display information of a service related to each of the payment methods on the display.

9. The wallet server according to claim 1, wherein the processor is configured to display the balance of each of the payment methods on the display.

10. A non-transitory computer-readable recording medium on which an executable program is recorded, the program causing a processor of a computer to execute:
displaying, on a display, a payment icon receiving a request for payment using any of a plurality of different payment methods, and additional information determined based on a result of comparison between a balance of each payment method and a predetermined amount.

11. The non-transitory computer-readable recording medium according to claim 10, wherein the additional information is information displaying a payment method, the payment method having the balance smaller than the predetermined amount, in a display mode different from those of other payment methods.

12. The non-transitory computer-readable recording medium according to claim 11, wherein the display mode is a mode in which the payment icon of the payment method with the balance smaller than the predetermined amount is displayed in a gray-out manner.

13. The non-transitory computer-readable recording medium according to claim 10, wherein the payment icons respectively include display of names of the payment methods or marks indicating the payment methods.

14. The non-transitory computer-readable recording medium according to claim 10, wherein a list of the plurality of payment icons is displayed on the display.

15. The non-transitory computer-readable recording medium according to claim 10, wherein a deposit button to receive a request for a deposit into a payment method is displayed on the display.

16. The non-transitory computer-readable recording medium according to claim 10, wherein the predetermined amount is a payment amount.

17. The non-transitory computer-readable recording medium according to claim 10, wherein information of a service related to each of the payment methods is displayed on the display.

18. The non-transitory computer-readable recording medium according to claim 10, wherein the balance of each of the payment methods is displayed on the display.

19. A wallet system comprising:
a server comprising a first processor comprising hardware, the first processor being configured to display, on a display, a payment icon receiving a request for payment using any of a plurality of different payment methods, and additional information determined based on a result of comparison between a balance of each payment method and a predetermined amount; and
a terminal comprising
a second processor comprising hardware, and
the display.

20. The wallet system according to claim 19, wherein the additional information is information displaying a payment method, the payment method having the balance smaller than the predetermined amount, in a display mode different from those of other payment methods.
